(19) United States
(12) Patent Application Publication
(10) Pub. No.: US 2012/0196242 A1
(43) Pub. Date: Aug. 2, 2012

(54) SUBSTRATE SUPPORT WITH HEATER AND RAPID TEMPERATURE CHANGE

(75) Inventors: LEON VOLFOVSKI, Mountain View, CA (US); MAYUR G. KULKARNI, San Jose, CA (US); ALEX MINKOVICH, Campbell, CA (US)

(73) Assignee: APPLIED MATERIALS, INC., Santa Clara, CA (US)

(21) Appl. No.: 13/014,827

(22) Filed: Jan. 27, 2011

(51) Int. Cl. F27B 19/00

(52) U.S. Cl. 432/92

(57) ABSTRACT

Embodiments of substrate supports with a heater and an integrated chiller are provided herein. In some embodiments, a substrate support may include a first member to distribute heat to a substrate when present above a first surface of the first member, a heater disposed beneath the first member and having one or more heating zones to provide heat to the first member, a plurality of cooling channels disposed beneath the first member to remove heat provided by the heater, a plurality of substrate support pins disposed a first distance above the first surface of the first member, the plurality of substrate support pins to support a backside surface of a substrate when present on the substrate support, and an alignment guide extending from the first surface of the first member and about the plurality of substrate support pins.

### FIELD

Embodiments of the present invention generally relate to substrate processing equipment, and more specifically to a substrate support.

### BACKGROUND

As the critical dimensions of devices continue to shrink, improved control over processes, such as heating, cooling, or the like may be required. For example, a substrate support may include a heater and/or chiller to provide a desired temperature of a substrate disposed on the substrate support during processing.

Thus, the inventors have provided an improved substrate support.

### SUMMARY

Embodiments of substrate supports with a heater and an integrated chiller are provided herein. In some embodiments, a substrate support may include a first member to distribute heat to a substrate when present above a first surface of the first member, a heater disposed beneath the first member and having one or more heating zones to provide heat to the first member; a plurality of cooling channels disposed beneath the first member to remove heat provided by the heater, a plurality of substrate support pins disposed a first distance above the first surface of the first member, the plurality of substrate support pins to support a backside surface of a substrate when present on the substrate support, and an alignment guide extending from the first surface of the first member and about the plurality of substrate support pins.

In some embodiments, a substrate support may include a first member to distribute heat to a substrate when present above a first surface of the first member, a plurality of substrate support pins extending from the first surface of the first member, the plurality of substrate support pins to support a backside surface of a substrate when present on the substrate support, an alignment guide extending from the first surface of the first member and about the plurality of substrate support pins, wherein the first member, each of the plurality of substrate support pins and the alignment guide are formed from the same material, and a second member having one or more heating zones disposed in the second member to provide heat to the first member and having a plurality of cooling channels disposed in the second member.

In some embodiments, a substrate support includes a first member to distribute heat to a substrate when present above an upper surface of the first member, a support layer disposed on the upper surface of the first member, wherein each of a plurality of substrate support pins extend from a surface of the support layer to support a backside surface of a substrate when present on the substrate support, an alignment guide extending from the upper surface of the first member and about the plurality of substrate support pins, a first layer disposed below the first member and having each of a one or more heating zones disposed proximate a first surface of the first layer and a second layer disposed below the first member and having each of the plurality of cooling channels formed in the second layer.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic view of a substrate support in accordance with some embodiments of the present invention.

FIGS. 2A-C depict cross-sectional views of portions of substrate supports in accordance with some embodiments of the present invention.

FIGS. 3A-C depict cross-sectional views of portions of substrate supports in accordance with some embodiments of the present invention.

FIG. 4 depicts a top view of a multi-zone heater in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of substrate supports having a heater and integrated chiller are disclosed herein. The inventive substrate support may advantageously facilitate one or more of heating a substrate, maintaining the temperature of a substrate, rapidly changing the temperature of a substrate, or uniformly distributing heat to or removing heat from a substrate.

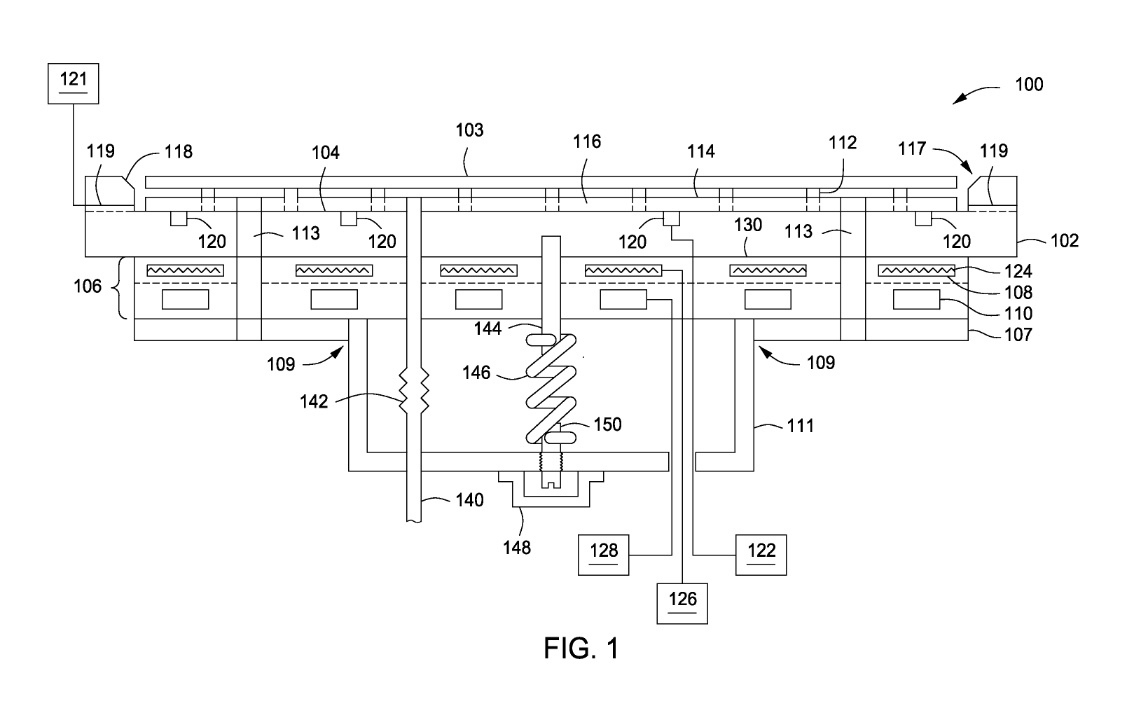

FIG. 1 depicts a substrate support 100 in accordance with some embodiments of the present invention. The substrate support 100 may include a first member 102 to distribute heat to a substrate 103 when present above a first surface 104 (e.g., an upper surface) of the first member 102 and a second member 106 having one or more heating zones 108 to provide heat to the first member 102 to be distributed and having a plurality of cooling channels 110. As shown in FIG. 1, the second member 106 can be disposed below the first member 102.

In some embodiments, the substrate support may provide temperatures ranging from about 450 degrees Celsius to about 600 degrees Celsius. However, embodiments of the substrate support disclosed herein are not limited to the above-mentioned temperature range. For example, the temperature may be lower, such as from about 150 degrees Celsius to about 450 degrees Celsius, or higher, such as greater than about 600 degrees Celsius.

In some embodiments, the substrate support 100 may include a third member 107 disposed below the first and second members 102, 106. The third member 107 may function as a facilities management plate, such as for wire and/or piping management to the one or more heating zones 108 and/or the plurality of cooling channels 110. In some embodiments, for example, when a plurality of cooling channels 110 are not used, the third member 107 may be used as a heat sink or the like. In some embodiments, the third member 107 may serve as an insulator, preventing convective losses to environment below. Alternatively, the third member 107 may additionally serve as a heat sink or the like when the plurality of cooling channels 110 are provided. The third member 107 may comprise MACOR® or any suitable ceramic material.

The third member 107 may include an opening 109, for example, centrally disposed through the third member 107. The opening 109 may be utilized to couple a feedthrough assembly 111 to the members 102, 106, and 107 of the substrate support 100. The feedthrough assembly 111 may feed various sources and/or control devices, such as a power source 126 to the one or more heating zones 108, a cooling source 128 to the plurality of cooling channels 110, or a controller 122 as discussed below. In some embodiments, the feedthrough assembly 111 may include a conduit 140 which can provide a gas from a gas source (not shown) to the backside of the substrate 103. For example, the gas provided by the conduit 140 may be utilized to improve heat transfer between the first member 102 and the substrate 103. In some embodiments, the gas is helium (He).

The conduit 140 may include a flexible section 142, such as a bellows or the like. Such flexibility in the conduit 140 may be necessary, for example, when the substrate support 100 is leveled. For example, the substrate support 100 may be leveled by one or more leveling devices (not shown) disposed about the feedthrough assembly 111 and through one or more members of the substrate support 110. For example, such leveling devices may include kinematic jacks or the like. As the leveling devices act to level the substrate support 100, flexibility in the conduit 140 may be necessary.

The members of the substrate support 100 may be coupled together by any number of suitable mechanisms. For example, suitable mechanisms may include gravity, adhesives, bonding, brazing, molding, mechanical compression, such as by screws, springs, clamps, or vacuum, or the like. A non-limiting exemplary form of mechanical compression is illustrated in FIG. 1. For example, a rod 144 may be disposed through one or several members of the substrate support 110 and used to compress the members with the feedthrough assembly 111. The rod 144 is illustrated as a single piece, but may be multiple pieces (not shown) connected together by a hinge, ball and socket structure or the like. The rod 144 may provide flexibility for leveling the substrate support 100, similar to as discussed above for the conduit 140.

The rod 144 may be coupled to the first member 102 for example through brazing, welding, or the like, or the rod 144 may be threaded and screwed into a corresponding threaded opening in the first member 102 that is configured to receive the rod 144 (not shown). An opposing end of the rod 144 may be coupled to the feedthrough assembly 111 via a spring 146. For example, a first end of the spring 146 may be coupled to the rod 144 and an opposing second end of the spring 146 may be coupled to the housing 111. As shown in FIG. 1, a bolt 150 disposed in the housing 111 is coupled to the second end of the spring 146. In some embodiments, a cover 148 may be provided over the bolt 150. Although the spring 146 is shown providing a compressive force to pull the rod 144 towards the feedthrough assembly 111, the spring 146 could also be configured to be preloaded in compression such the coupling force is provided by the expansion of the spring 146.

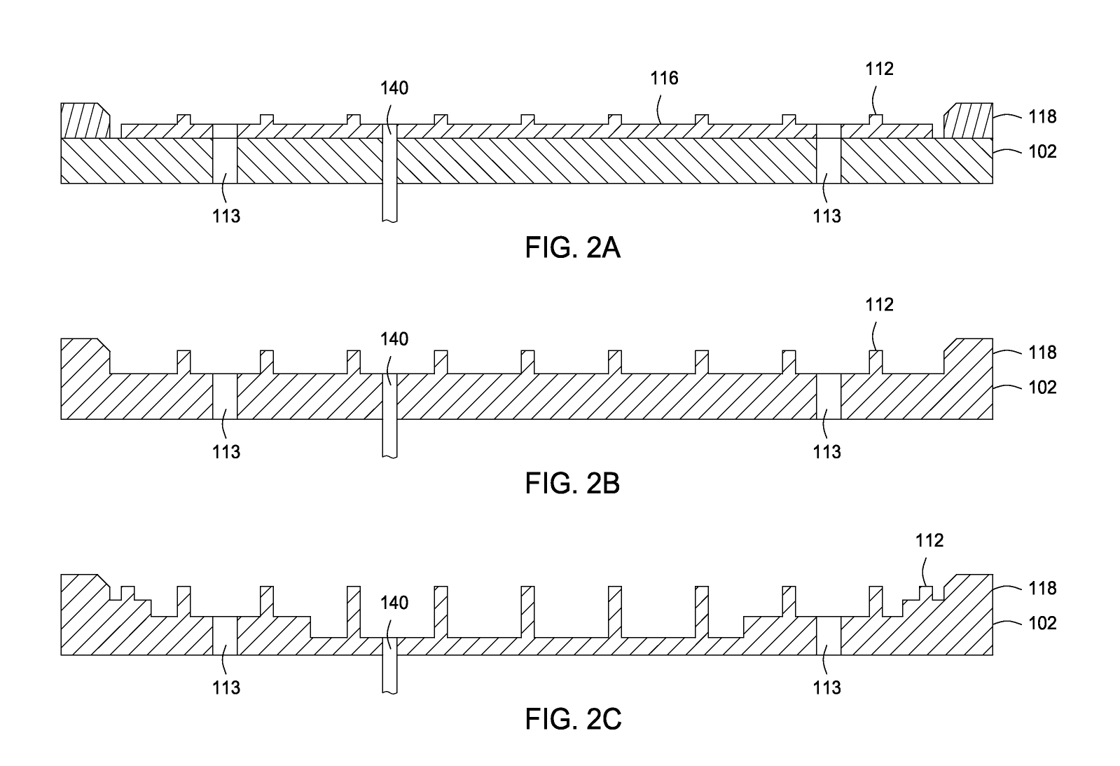

In some embodiments, the substrate support 100 may include a plurality of substrate support pins 112 disposed a first distance above the first surface 104 of the first member 102, the plurality of substrate support pins 112 can support a backside surface of the substrate 103 when present on the substrate support. In some embodiments, (as illustrated by the dotted lines proximate each support pin 112) each of the plurality of substrate support pins may extend from the first surface 104 of the first member 102 (e.g., the substrate support pins may be a part of, and formed in the first member 102). Alternatively, in some embodiments, a support layer 116 may be disposed on the first surface 104 of the first member 102 and each of the plurality of substrate support pins 112 may extend from a surface 114 of the support layer 116. In some embodiments, the support layer 116 and the each of the plurality of substrate support pins 112 may be formed from the same material. For example, the support layer 116 and the each of the substrate support pins 112 may be a one-piece structure (illustrated in FIG. 2A and discussed below). The support layer and each of the plurality of substrate support pins 112 can be formed of suitable process-compatible materials having wear resistant properties. For example, materials may be compatible with the substrate, with processes to be performed on the substrate, or the like. In some embodiments, the support layer 116 and/or the substrate support pins 112 may be fabricated from a dielectric material. In some embodiments, the materials used to form the support layer 116 and/or the substrate support pins 112 may include one or more of a polyimide (such as KAPTON®), aluminum oxide (Al₂O₃), aluminum nitride (AlN), silicon dioxide (SiO₂), silicon nitride (Si₃N₄), or the like. In some embodiments, for example for low temperature applications (e.g., at temperatures below about 200 degrees Celsius), the support layer 116 and/or the substrate support pins 112 may comprise KAPTON®.

In some embodiments, the substrate support 100 may include an alignment guide 118 extending from the first surface 104 of the first member 102 and about the plurality of substrate support pins 112. The alignment guide 118 may serve to guide, center, and/or align the substrate 103, such as with respect to the one or more heating zones 108, the cooling channels 110 disposed below the substrate 103, for example, when the substrate is lowered onto the substrate support pins 112 by a plurality of lift pins (not shown—lift pins holes 113 are illustrated in FIG. 1 and may extend through support layer 116 and first and second member 102, 106). The alignment guide may include one or more purge gas channels 119 disposed through and about the alignment guide 118 (as illustrated in FIG. 1) and/or disposed proximate a peripheral edge of the substrate 103, such as in the first member 102 (not shown). The one or more purge gas channels 119 may be coupled to a purge gas source 121 which can provide a purge gas through the one or more purge gas channels 119. For example, the purge gas may be provide to limit the deposition of materials on the backside of the substrate 103 during processing. The purge gas may include one or more of helium (He), nitrogen (N₂), or any suitable inert gas. The purge gas may be exhausted via a gap 117 proximate the edge of the substrate 103. The purge gas exhausted through the gap 117 may limit or prevent process gases from reaching and reacting with a backside of the substrate 103 during processing. The purge gas may be exhausted from the process chamber via the exhaust system of the process chamber (not shown) to appropriately handle the exhausted purge gas.

The alignment guide 118 may be formed of suitable process compatible materials, such as materials having wear resistant properties and/or a low coefficient of thermal expansion. The alignment guide 118 may be a single piece or an assembly of multiple components. In some embodiments, the alignment guide 118 may be fabricated from a dielectric material. For example, suitable materials used to form the alignment guide 118 may include one or more of CELAZOLE® PBI (polybenzlmidazole), aluminum oxide (Al₂O₃), or the like. Generally, materials for any of the various components of the substrate support 100 may be selected based on chemical and thermal compatibility of the materials with each other and/or with a given process application.

The first member 102 may be utilized to distribute heat to the substrate 103. For example, the first member may act as a heat spreader to diffuse the heat provided by the one or more heating zones 108. In some embodiments, the first member 102 may include one or more temperature monitoring devices 120 embedded in the first member 102 or extending through the first member 102 to monitor the temperature being provided to the substrate 103 at one or more positions along the first surface 104 of the first member 104. The temperature monitoring devices 120 may include any suitable device for monitoring temperature, such as one or more of a temperature sensor, rapid thermal detector (RTD), optical sensor, or the like. The one or more temperature monitoring devices 120 may be coupled to a controller 122 to receive temperature information from each of the plurality of the temperature monitoring devices 120. The controller 122 may further be used to control the heating zones 108 and the cooling channels 110 in response to the temperature information, as discussed further below. The first member 102 may be formed of suitable process-compatible materials, such as materials having one or more of high thermal conductivity, high rigidity, and a low coefficient of thermal expansion. In some embodiment, the first member 102 may have a thermal conductivity of at least about 160 W/mK. In some embodiment, the first member 102 may have a coefficient of thermal expansion of about 9×10⁻⁶/° C. or less. Examples of suitable materials used to form the first member 102 may include one or more of aluminum (Al), copper (Cu) or alloys thereof, aluminum nitride (AlN), beryllium oxide (BeO), pyrolytic boron nitride (PBN), silicon nitride (Si₃N₄), aluminum oxide (Al₂O₃), silicon carbide (SiC), or the like.

Variations of the first member 102, the plurality of substrate support pins 112, and the alignment guide 118 are possible. For example, such variations may depend on the process being performed on the substrate 103 and/or the composition of the substrate 103. For example, depending on temperature requirements for a given process, the first member 102 may be formed of a material having a specific thermal conductivity or the like; however, such a material may contaminate the substrate 103 if the backside of the substrate 103 is exposed to the first surface 104 of the first member 102. Accordingly, the support layer 116 may be utilized under such conditions and be formed of a different material than the first member 102, where the different material will not contaminate the substrate 103. Similarly, the alignment guide 118 may be formed of a different material than the first member 102 for a similar reason. For example, FIG. 2A depicts an embodiment of the substrate support 102 which includes the alignment guide 118, the support layer 116 and the plurality of support pins extending from the support layer 116, and the first member 102, wherein the alignment guide 118 and the support layer 116 and support pins 112 are formed from different materials than the first member 102.

Alternatively, depending on the process being performed on the substrate 103 and/or the composition of the substrate 103, the first member 102, the plurality of substrate support pins 112, and the alignment guide 118 may be formed of the same material as illustrated in FIG. 2B. For example, wherein the material of the first member is compatible with the process being performed on the substrate 103 and/or the composition of the substrate 103, then embodiments of the substrate support 100 as shown in FIG. 2B may be used. As the support layer 116 is integral with the first member 102 in FIG. 2B, a separate support layer 116 is not shown in FIG. 2B. However, the support layer 116 may be considered to be an upper portion of the first member 102.

Alternatively, depending on the process being performed on the substrate 103 and/or the composition of the substrate, the first member 102 may vary in thickness as illustrated in FIG. 2C. For example, the thickness variation along the first member 102 may facilitate a desired heating profile along the substrate 103 and/or compensate for non-uniformities in a process being performed on the frontside surface of the substrate 103, such as deposition, curing, baking, annealing, etching, and others. For example, in some embodiments, as illustrated in FIG. 2C, the first member 102 may increase in thickness from the center to an edge of the first member 102. However, the embodiments of FIG. 2C are merely illustrative, and the thickness of the first member 102 may be varied in any suitable manner to provide a desired heating profile along the substrate 103. As illustrated in FIG. 2C, when the thickness of the first member 102 is varied, the plurality of support pins 112 may have varying lengths to compensate for the thickness variation in the first member 102. As shown in FIG. 2C, each support pin 112 has a length such that it contacts a backside surface of the substrate 103 at about the same vertical height. The plurality of support pins 112 may be individually fashioned and coupled to the first member 102 as illustrated in FIG. 2C. Alternatively, (not shown) the plurality of support pins 112 may be integral with the first member 102, for example, similar to the embodiments of the support pins 112 shown in FIG. 2B.

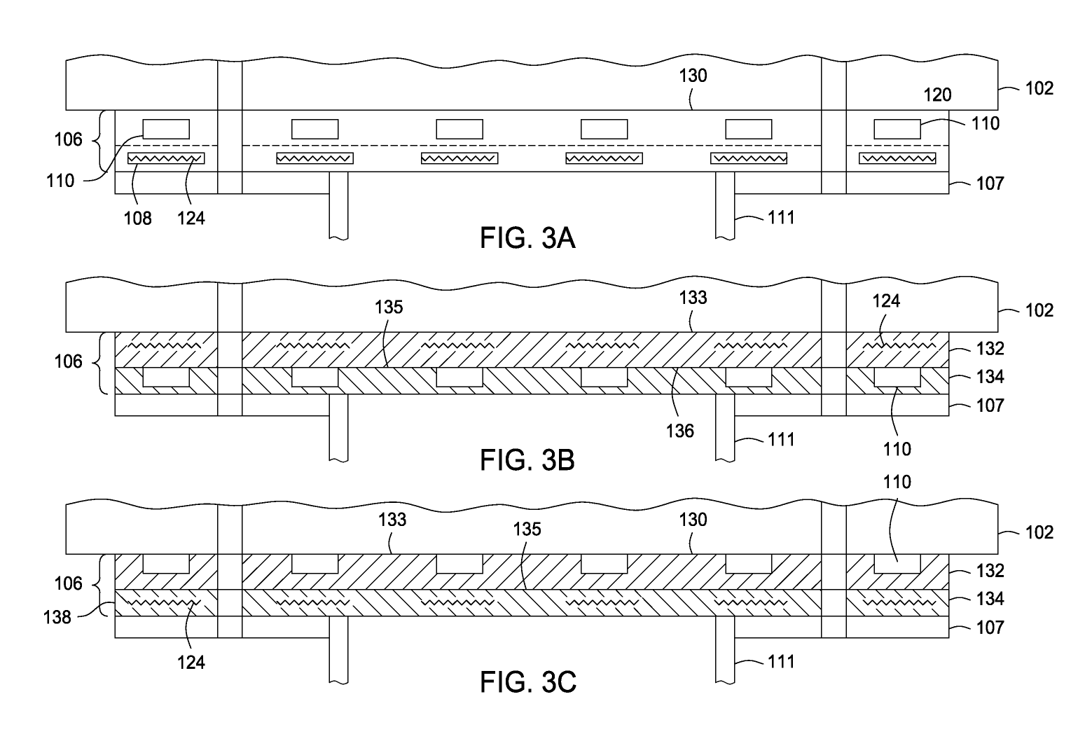

Returning to FIG. 1, the second member 106 may have both the one or more heating zones 108 and the cooling channels 110 formed therein or thereon the second member 106, or alternatively, as depicted by the dotted line disposed through the second member 106, the second member 106 may have multiple layers, where one layer includes one of the heating zones 108 or the cooling channels 110, and another layer includes the other of the heating zones 108 or the cooling channels 110. Although illustrated in FIGS. 1 and 3A-D as being uniformly distributed along the second member 106, the one or more heating zones 108 and cooling channels 110 may be distributed in any suitable configuration along the second member 102 that is desired to provide a desired temperature profile on the substrate 103. The second member 106 may be formed of suitable process-compatible materials, such as materials having one or more of high mechanical strength (e.g., Bending strength at least about 200 MPa), high electrical resistivity (e.g., at least about 10¹⁴ ohm-cm), a low coefficient of thermal expansion (e.g., no more than about 5×10⁻⁶° C.). Suitable materials may include one or more of silicon carbon (SiC), silicon nitride (Si₃N₄), aluminum nitride (AlN), aluminum oxide (Al₂O₃), or the like.

The substrate support 100 includes one or more resistive heating elements 124. Each of the one or more heating zones 108 includes one or more resistive heating elements 124. Each of the resistive heating elements 124 may be coupled to a power source 126. The power source 126 may provide any suitable type of power, such as direct current (DC) or alternating current (AC), which is compatible with the resistive heating elements 124. The power source 126 may be coupled to and controlled by the controller 122 or by another controller (not shown), such as a system controller for controlling a process chamber having the substrate support disposed therein, or the like. In some embodiments, the power source 126 may further include a power divider that divides the power provided to the resistive heating elements 124 in each heating zone 108. For example, the power divider may act in response to one or more of the temperature monitoring devices 120 to selectively distribute power to the resistive heating elements 124 in specific heating zones 108. Alternatively, in some embodiments, multiple power sources may be provided for the resistive heating elements in each respective heater zone.

In some embodiments, the one or more resistive heating elements 124 may be deposited onto a surface of the second member 106. For example, deposition may include any suitable deposition technique for forming a desired pattern of heating zones 108. For example, the one or more resistive heating elements may comprise platinum or other suitable resistive heating materials. In some embodiments, after the deposition of the one or more resistive heating elements 124 is complete, the surface of the second member 106 and the deposited one or more resistive heating elements 124 may be coated with an insulating material, such as a glass, ceramic, or the like.

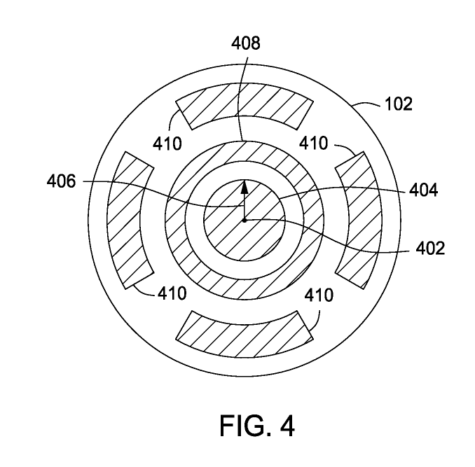

For example, one embodiment of a configuration of the one or more heating zones 108 arranged into six zones is illustrated in FIG. 4, although greater or fewer zones may also be used. As shown in a top view, the heating zones 108 may be disposed about a central axis 402 of the substrate support 100. The one or more heating zones 108 may include a first heating zone 404 having a first radius 406 extending from the central axis 402 along the upper surface of the second member 106 (e.g., a central zone), a second heating zone 408 circumscribing the first heating zone 404 (e.g., a middle zone), and a third, fourth, fifth, and sixth heating zones 410 disposed about the second heating zone 408 (e.g., a plurality of outer zones). In some embodiments, and as shown, each of the four heating zones 410 may correspond to about one quarter of the outer region of the substrate support 100. In some embodiments, a temperature monitoring device (such as the temperature monitoring device 120 discussed above) may be provided to sense data corresponding to the temperature within each zone (or at a desired location within each zone). In some embodiments, each temperature monitoring device is an RTD. Each of the temperature monitoring devices may be coupled to the controller (such as controller 122 discussed above) to provide feedback control over each corresponding heating zone 108.

Returning to FIG. 1, the cooling channels 110 may be coupled to a cooling source 128 which may provide coolant to the cooling channels 110. The coolant may be a liquid or gas, for example, such as water, an inert gas, or the like. The cooling channels 110 may be interconnected, or alternatively, the cooling channels 110 may be arranged into a plurality of zones. The zones may coincide with one or more of the one or more heating zones 108. For example, each heating zone 108 may have a corresponding cooling zone, or the cooling zones may correlate to, or be disposed adjacent to plural heating zones 108. Coolant may be distributed to each coolant channel as desired, or in response to temperature information provided by one or more of the temperature monitoring devices 120 in a similar manner as discussed above for the heating zones 108. For example, the delivery of the coolant to the coolant channels from the coolant source 128 can be controlled by the controller 122 in a similar manner as discussed above for the heating zones 108. For example, the temperature, flow rate, or the like of the coolant may be controlled to remove heat as desired from the substrate support in order to control the thermal profile of a substrate disposed on the substrate support 100.

The compact design of the substrate support 100, the tunability of heating and cooling to adjust for temperature non-uniformities on the substrate 103, and the presence of an active cooling mechanism (e.g., the coolant channels 110 and associated coolant devices) can facilitate one or more of heating a substrate, maintaining the temperature of a substrate, rapidly changing the temperature of a substrate, or uniformly distributing heat to or removing heat from a substrate.

The second member 106 may comprise one or more layers fabricated from the same or different materials. For example, several non-limiting variations of the second member 106 are illustrated in the embodiments shown in FIGS. 3A-C. For example, as shown in FIG. 3A, the positioning of the cooling channels 110 and the heating zones 108 may be reversed with respect to the embodiments of the second member 106 as illustrated in FIG. 1. As illustrated in FIG. 1, the heating zones 108 may be between the cooling channels 110 and the first member 102. Alternatively, as illustrated in FIG. 3A, the cooling channels may be disposed between the heating zones 108 and the first member 102. In some embodiments, each of the one or more cooling channels 110 may be disposed in a planar orientation, parallel to a first surface 130 of the second member 106, adjacent to the first member 102. Similarly, In some embodiments, each of the one or more heating zones 108 may be disposed in a planar orientation, parallel to the first surface 130 of the second member 106. As discussed above, although illustrated as being parallel to the upper surface 130 and uniformly distributed along the second member 106, the heating zones 108 and the cooling channels 110 can assume any suitable configuration to provide a desired temperature profile on the substrate 103. For example, the heating zones 108 and/or cooling channels 110 can be staggered with respect to the upper surface 130 and/or non-uniformly distributed.

In some embodiments, the second member 106 may be formed of a first layer 132 and a second layer 134. As illustrated in FIG. 3B, the first layer 132 may include each of the one or more heating zones 108 where each of the heating zones 108 is disposed proximate or on an upper surface 133 of the first layer 132. For example, each of the heating elements 124 can be embedded in the first layer 132 as shown in FIG. 3B. Alternatively, each of the heating elements 124 may be disposed atop the first layer 132 (not shown) for example by printing the heating elements 124 onto the upper surface 133 or by another suitable lithography or deposition technique. Similarly, the one or more heating elements 124 may be disposed on the upper surface 130 of the second member 106, for example, when the second member 106 is formed of a single layer (not shown). For example, the first layer 132 may be formed of suitable process-compatible materials, such as one or more of AlN, Si₃N₄, MACOR® (a machineable glass-ceramic available from Corning Incorporated comprising fluorphlogopite mica in a borosilicate glass matrix), ZERODUR® (a glass-ceramic available from Schott AG), stainless steel or the like. For example, the first layer 132 may be a multilayer or laminate structure, for example, comprising several of the process-compatible materials listed above.

The second layer 134 may have the plurality of cooling channels 110 disposed in an upper surface 135 of the second layer 134 as shown in FIG. 3B. Alternatively, the plurality of cooling channels can be disposed within the interior of the second layer 134 (not shown). The second layer 134 may be formed of suitable process-compatible materials, such as one or more of AlN, Si₃N₄, MACOR®, ZERODUR®, stainless steel or the like. For example, the second layer 134 may be a multilayer or laminate structure, for example, comprising several of the process-compatible materials listed above.

In some embodiments, the first layer 132 may be disposed above the second layer 134. For example, as illustrated in FIG. 3B, each of the heating zones 108 disposed on the upper surface 133 of the first layer 132 may contact a lower surface of the first member 102, however, direct contact of the lower surface of the first member 102 is not required. Further, the upper surface 135 of the second layer 134 having the cooling channels 110 disposed therein may contact a lower surface 136 of the first layer 132 as illustrated in FIG. 3B, although direct contact is not required. As such, the upper surface 133 of the first layer 132 contacts the lower surface of the first member 102. The contact can be direct, as shown, or indirect (e.g., with some intervening layer present). The upper surface 135 of the second layer 134 contacts the lower surface 136 of the first layer 132. The contact can be direct, as shown, or indirect (e.g., with some intervening layer present).

Alternatively, the second layer 134 may be disposed above the first layer 134 as illustrated in FIG. 3C. For example, as illustrated in FIG. 3C, the upper surface 135 of the second layer 134 may contact the lower surface of the first member 102. The heating elements 124 may be embedded in the first layer 132 or disposed atop the upper surface 133 of the first layer 132 and may come into near contact with or contact with a lower surface 138 of the second layer 134.

Thus, embodiments of substrate supports have been disclosed herein. The inventive substrate support may advantageously facilitate one or more of heating a substrate, maintaining the temperature of a substrate, rapidly changing the temperature of a substrate, or uniformly distributing heat to or removing heat from a substrate.

While the foregoing is directed to embodiments of the present invention, other and further embodiments of the invention may be devised without departing from the basic scope thereof.

1. A substrate support, comprising:
a first member to distribute heat to a substrate when present above a first surface of the first member;
a heater disposed beneath the first member and having one or more heating zones to provide heat to the first member;
a plurality of cooling channels disposed beneath the first member to remove heat provided by the heater;
a plurality of substrate support pins disposed a first distance above the first surface of the first member, the plurality of substrate support pins to support a backside surface of a substrate when present on the substrate support; and
an alignment guide extending from the first surface of the first member and about the plurality of substrate support pins.

2. The substrate support of claim 1, wherein each of the plurality of substrate support pins extends from the first surface of the first member.

3. The substrate support of claim 2, wherein the first member, the plurality of substrate support pins and the alignment guide are formed from the same material.

4. The substrate support of claim 1, further comprising:
a support layer disposed on the first surface of the first member, wherein each of the plurality of substrate support pins extend from a surface of the support layer.

5. The substrate support of claim 4, wherein each of the plurality of substrate support pins and the support layer are formed from the same material.

6. The substrate support of claim 1, further comprising:
a plurality of resistive heating elements, wherein each of the one or more heating zones comprises one or more resistive heating elements of the plurality of resistive heating elements.

7. The substrate support of claim 6, further comprising:
a second member disposed beneath the first member, wherein each of the plurality of heating elements are disposed proximate an upper surface of the second member and wherein each of the plurality of cooling channels are disposed in the second member parallel to the upper surface.

8. The substrate support of claim 6, further comprising:
a second member disposed beneath the first member, wherein each of the plurality of cooling channels are disposed in the second member parallel to an upper surface and wherein each of the plurality of heating elements are disposed in the second member and below each of the plurality of cooling channels.

9. The substrate support of claim 6, further comprising:
a first layer having the plurality of heating elements formed in the first layer; and
a second layer having each of the plurality of cooling channels formed in the second layer.

10. The substrate support of claim 9, wherein each of the plurality of cooling channels is formed in an upper surface of the second layer.

11. The substrate support of claim 10, wherein a lower surface of the first layer contacts the upper surface of the second layer to form the plurality of cooling channels.

12. The substrate support of claim 10, wherein the upper surface of the second layer contacts a lower surface of the first member to form the plurality of cooling channels.

13. The substrate support of claim 12, wherein the first layer is disposed below the second layer.

14. The substrate support of claim 6, wherein the one or more heating zones are disposed about a central axis of the substrate support.

15. The substrate support of claim 14, wherein the one or more heating zones further comprises:
a first heating zone having a first radius extending from the central axis along the upper surface of the second member;
a second heating zone disposed about the first heating zone; and
a plurality of third heating zones disposed about the second heating zone.

16. The substrate support of claim 1, further comprising:
a third member disposed beneath the one or more heating zones and the plurality of cooling channels.

17. The substrate support of claim 16, wherein in the third member is a heat sink.

18. A substrate support, comprising:
a first member to distribute heat to a substrate when present above a first surface of the first member;
a plurality of substrate support pins extending from the first surface of the first member, the plurality of substrate support pins to support a backside surface of a substrate when present on the substrate support;
an alignment guide extending from the first surface of the first member and about the plurality of substrate support pins, wherein the first member, each of the plurality of substrate support pins and the alignment guide are formed from the same material; and
a second member having a plurality of heating elements disposed in the second member and disposed proximate to a second surface of the second member to provide heat to the first member to be distributed and having a plurality of cooling channels disposed in the second member.

19. A substrate support, comprising:
a first member to distribute heat to a substrate when present above an upper surface of the first member;
a support layer disposed on the upper surface of the first member, wherein each of a plurality of substrate support pins extend from a surface of the support layer to support a backside surface of a substrate when present on the substrate support;
an alignment guide extending from the upper surface of the first member and about the plurality of substrate support pins;
a first layer disposed below the first member and having a plurality of heating elements disposed in the first layer; and
a second layer disposed below the first member and having each of the plurality of cooling channels formed in the second layer.

20. The substrate support of claim 19, wherein the second layer is disposed above the first layer.
